(19) United States
(12) Patent Application Publication
(10) Pub. No.: US 2016/0109394 A1
(43) Pub. Date: Apr. 21, 2016

(54) OVERLAYER INTENDED TO COVER AN OBJECT, IN PARTICULAR A CABLE, IN ORDER TO DETECT AND/OR LOCATE A DEFECT ON THE SURFACE OF SAME

(71) Applicant: COMMISSARIAT A L'ENERGIE ATOMIQUE ET AUX ENERGIES ALTERNATIVES, Paris (FR)

(72) Inventors: Fabrice AUZANNEAU, Massy (FR); Yannick BONHOMME, Breuillet (FR)

(21) Appl. No.: 14/787,746

(22) PCT Filed: Apr. 24, 2014
(86) PCT No.: PCT/EP2014/058313

§ 371 Date: Oct. 28, 2015

(30) Foreign Application Priority Data
May 7, 2013 (FR) 1354158

(51) Int. Cl. G01N 27/02; H01B 1/02; H01B 7/32

(52) U.S. Cl. CPC G01N 27/028; H01B 7/32; H01B 1/02

(57) ABSTRACT

An overlayer intended to cover an object in order to detect a defect on a surface of the object, comprises an assembly made up of a plurality of current-conducting wire elements of different mechanical resistances and a means for insulating the conducting wire elements, each conducting wire element being arranged such as to at least partially cover a surface of the object when the overlayer covers the object, each conducting wire element being arranged to allow the connection thereof to a test device for detecting a defect affecting the conducting element.

The invention relates to an overlayer intended to cover an object, for example a mechanical cable or part, with the aim of detecting a defect, of the rubbing or heating type, at the surface of this object.

The invention also relates to a test assembly made up of an overlayer and of a continuity test or reflectometry test detection or electric test device.

Electric and mechanical devices or other objects can be subjected to various external stresses which can cause one or more alterations or deteriorations of one or more of the surface components thereof. For example, an electric cable can suffer deterioration through mechanical rubbing producing an alteration of the cable and more particularly of the insulating material covering the cable.

To prevent a failure or a malfunction of the system, a preventative detection of these deteriorations is necessary. Together with locating the deterioration, a preventative detection allows the maintenance or the repair of the altered object to be targeted as early as possible.

A problem therefore arises with regard to designing a solution for preventatively detecting an alteration of the surface of an object.

With regard to the field of electric cables, so-called reflectometry systems and methods are known which consist in injecting a test signal into the cable and in analyzing the reflection of this signal in order to identify irregularities.

This type of method operates correctly for the detection of resistive fault, short circuit or open circuit interruptions but does not allow a rubbing, temperature increase or pinch surface fault to be detected with a sufficient level of reliability.

The US patent application published under the number US 2005/0184738 moreover describes a system for detecting rubbing at the surface of an electric cable. The proposed solution is based on the use of fiber-optical waveguides which has disadvantages associated with the integration, connection and repair difficulties, due notably to the rigidity of the fiber-optical waveguides and a high operating cost.

The PCT application published under the number WO 2007/130683 describes a solution of an overlayer made up of an assembly of cables for carrying out a vibration measurement and for detecting a fault by assimilation with a vibration. To implement this detection, the overlayer is instrumented with a vibration sensor network. This solution also has a large operating cost and spatial requirement. Furthermore, it does not allow the detection of local heating.

The present invention allows the aforementioned disadvantages to be overcome by proposing an overlayer made up of an electrically conductive element infrastructure which can be arranged on or integrated into an object, for example a cable. Using a test solution of the continuity test or reflectometry test type, or any other equivalent electric test, it allows a preventative detection of the failures or also location to be offered.

The object of the invention is an overlayer intended to cover an object in order to detect a fault on a surface of said object, characterized in that it comprises an assembly made up of a plurality of current-conducting wire elements (601, 602, 603) of different mechanical resistances and a means for insulating said conducting wire elements, each conducting wire element being arranged such as to at least partially cover a surface of said object when the overlayer covers said object, each conducting wire element being arranged to allow the connection thereof to a test device for detecting a fault affecting said conducting element.

According to a particular aspect of the overlayer according to the invention, it comprises at least a pair of current-conducting wire elements which are connected at one of the ends thereof by a short circuit or an electric load, and are arranged such that a test signal can be injected at the other end of one of said elements of the pair.

According to a particular aspect of the overlayer according to the invention, the accuracy for detecting a fault at the surface of the overlayer is configured according to the spacing between two adjacent spires of the pair of conducting wire elements.

According to a particular aspect of the overlayer according to the invention, the mechanical resistance of a conducting wire element is configured according to the diameter of said element or to the thickness of the insulating means or to the type of material from which the conducting wire element is made up.

According to several particular aspects of the overlayer according to the invention, a conducting wire element is made up of copper or aluminum, said current-conducting wire element is a nanowire, the insulating means is integrated into said conducting element or is an insulating layer shaped to cover said object and wherein said conducting element is embedded. The overlayer according to the invention can also comprise an adhesive surface for adhering to said object.

The object of the invention is also a test system for detecting a fault at the surface of an object comprising an overlayer according to the invention, which overlayer is shaped to cover said object or a part of it and a test device configured to implement an electric test for detecting a fault affecting at least one conducting wire element of the overlayer.

The test device can be integrated into the overlayer. It can be suitable for implementing a reflectometry test.

According to a particular embodiment of the invention, the overlayer includes a plurality of pairs of conducting wire elements of different lengths and the test device is suitable for carrying out a spatial interpolation of the reflectograms measured on each pair of conducting wire elements.

Another object of the invention is a use of a test system according to the invention wherein the overlayer comprises at least three current-conducting wire elements connected together at one of the ends thereof by a short circuit or an electric load, consisting in successively carrying out a detection test on each pair of conducting wire elements, which pair is taken from said conducting wire elements, such as to assess the extent of the fault affecting an area of the surface of the overlayer.

Another object of the invention is a use of a test system according to the invention consisting in successively carrying out a detection test on a plurality of conducting wire elements of different mechanical resistances and in producing a detection warning level weighted according to the mechanical resistance of said conducting wire element on which a fault has been detected.

Another object of the invention is a use of a test system according to the invention, which test system is used for a cable network wherein at least one different conducting wire element is positioned at the surface of each segment of the cable network, a detection successive test on each conducting wire element allowing the segment of the network affected by the detected fault to be identified.

Another object of the invention is a use of a test system according to the invention according to which said overlayer is used as a tactile interface by the detection of a rubbing fault at the surface thereof.

Other features and advantages of the present invention will emerge more clearly upon reading the following description with reference to the appended drawings wherein:

FIG. 1 is a sectional view of a cable covered with an overlayer according to a first embodiment of the invention,

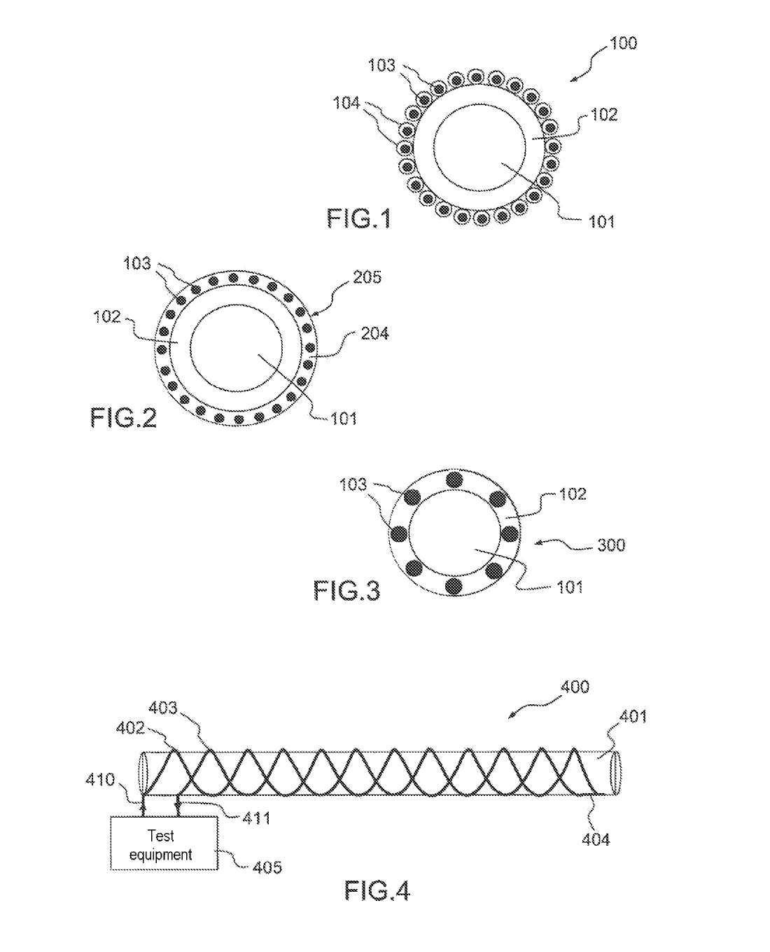

FIG. 2 is a sectional view of a cable covered with an overlayer according to a second embodiment of the invention,

FIG. 3 is a sectional view of a cable integrating an overlayer according to a third embodiment of the invention,

FIG. 4 is a diagram of a test assembly according to a particular embodiment of the invention,

FIG. 5 is a diagram illustrating, for the particular embodiment of FIG. 4, an improvement in the accuracy for detecting a fault at the surface of the overlayer,

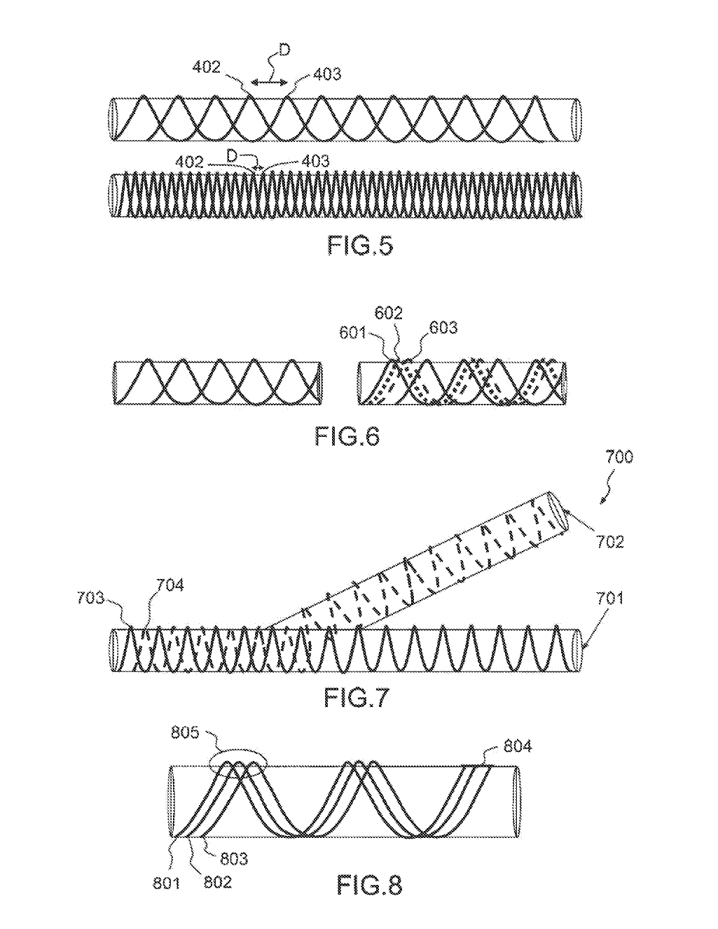

FIG. 6 is a diagram illustrating a particular embodiment of the invention using conducting elements of different mechanical resistances,

FIG. 7 is a diagram illustrating a possible use of the invention for locating faults on a branched cable,

FIG. 8 is a diagram illustrating a particular embodiment of the invention including redundancy areas to improve the accuracy of the extent of detecting a fault,

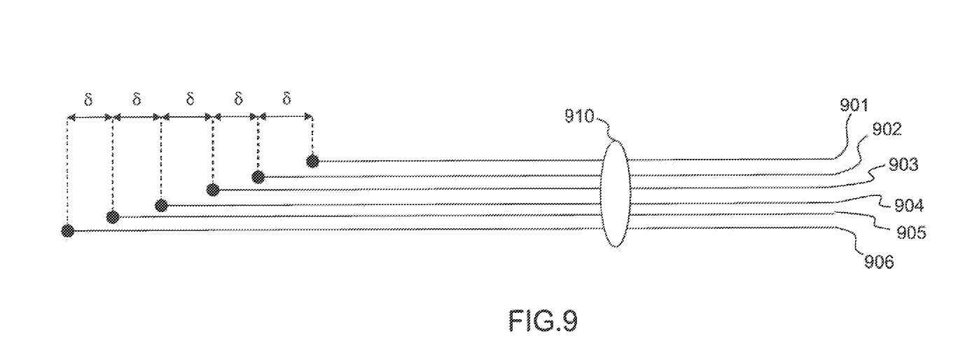

FIG. 9 is a diagram illustrating another particular embodiment of the invention including redundancy areas and allowing the accuracy for locating a fault to be improved.

The invention is now described by taking the example of a cable, or of a network of cables, on which the intention is to detect a fault, for example a rubbing fault, affecting the surface of this cable or of one of the branches of the network of cables.

The cable example is given purely by way of illustration and is in no way limiting to the scope of the invention. The overlayer according to the invention is used for any object, for example any mechanical system, having a surface that may suffer deterioration.

In particular, but not exclusively, the invention is also used for any body element of a vehicle, for example a bumper or a door of a vehicle, or for any type of electric or mechanical cable.

The fault type that can be detected by the invention notably comprises the rubbing, heating, acid and chemical attack faults or more generally any type of fault leading to a deterioration of the surface of an object or an interruption brought about, for example, by pinching or a pressure. If a particular type of stress is sought, the structure or the composition of the overlayer will be chosen or designed accordingly.

A person skilled in the art can, of course, use the invention for any object that is not explicitly described in the present application and for the detection of other types of faults equivalent to those mentioned above or leading to the same phenomena that can be detected by using the overlayer according to the invention.

FIG. 1 shows a sectional view of a cable covered with an overlayer according to a first embodiment of the invention.

The cable 101 is surrounded by a first integrated insulating layer 102 then by an overlayer formed from a plurality of current-conducting elements 103. Each conducting element is surrounded by an insulating layer 104. The insulated current-conducting elements are arranged at the periphery of the insulating layer 102 of the cable 101 such as to form an overlayer. The current-conducting elements 103 can, notably, be designed from copper or aluminum or more generally from any type of electrically conductive material.

The assembly 100 formed from the cable covered with the overlayer according to the invention forms a cable suitable for allowing the detection of deterioration at the surface thereof.

In the diagram of FIG. 1, a plurality of conducting elements, 103, 104 positioned over the entire circumference, of the cable is shown. As will be explained below, the number of conducting elements is not limited and notably depends on the desired detection accuracy. Indeed, the greater the number of the conducting elements, the more the surface is protected, therefore increasing the accuracy for detecting a fault at any point of the surface.

FIG. 2 shows a sectional view of a cable covered with an overlayer according to a second embodiment of the invention.

In this second embodiment, the current-conducting elements 103 are embedded in an insulating layer 204, the assembly 205 forming the overlayer according to the invention to be used on the periphery of the insulating layer 102 of the cable.

An advantage of this second embodiment is that the assembly formed from the conducting elements and from the insulating material is molded as a single piece which simplifies the manufacture of the overlayer.

FIG. 3 shows a sectional view of a cable integrating an overlayer according to a third embodiment of the invention.

In this third embodiment, the current-conducting elements 103 are directly integrated within the insulating layer 102 of the cable 101.

The cable 300 that is modified in this manner is suitable for allowing the detection of faults at the surface thereof.

In all of the embodiments, the overlayer according to the invention includes one or more access ports for connecting, to one or more ends of at least one conducting element, an electric test device for the detection of a fault at the surface of said conducting elements.

An electric test for detecting a fault can be a reflectometry test, for example a time-domain or frequency-domain reflectometry test, known to a person skilled in the art who is a specialist in the field of the electric cable diagnostic systems. This test notably consists in injecting a test signal into a conducting element and measuring the signal propagated towards the output of a conducting element such as to detect an irregularity affecting the conducting element(s).

An electric test for detecting a fault can also be a continuity test wherein the aim is to detect a break in propagation of the current in the conducting element, such a break being, for example, linked to a local cut-off of the conducting element. A detection test can, for example, be carried out using an ohmmeter or any equivalent device carrying out this function.

An irregularity in the cable corresponds to a modification in the conditions of propagation of the signal in this cable. It results most often from a fault which locally affects the characteristic impedance of the cable by causing an interruption in the line parameters thereof.

By associating a detection test, of the continuity test or reflectometry test type, with the overlayer according to the invention, it is therefore possible to detect a local fault affecting one or more conducting elements of the overlayer.

The principle of the invention is based on the fact that the overlayer is stressed before the surface on which it is deposited, and that a break in the metal elements of the overlayer corresponds to the indication of a potential deterioration of the surface at this site (if the overlayer was absent). The electric test (continuity, reflectometry, or other, measurement) carried out allows this break to be detected, or located. With knowledge of the site of the stress, the maintainer will be able to modify the local configuration of the surface (typically move it away from the element on which it rubs or remove the source of the stress) in order to eliminate the causes of this deterioration (such that the future uses are free thereof) and possibly repair or replace the overlayer locally.

FIG. 4 shows a diagram of a test assembly according to a particular embodiment of the invention.

A particular arrangement of the overlayer according to the invention used on a cable 401 is shown in FIG. 4. According to this arrangement, the overlayer comprises a pair of current-conducting wire elements 402, 403 arranged in a spiral about the cable. The two conducting wire elements 402, 403 are connected at one end by a short circuit or an electric load 404, for example a resistive, capacitive or inductive load. The free ends of the two conducting elements 402, 403 are connected to a detection test device 405 of the type described above.

The implementation of the detection test consists, for example, in injecting a test signal at the end 410 of a first conducting element 402 and measuring the signal propagated at the end 411 of the second conducting element 403.

The detection test carried out by the device 405 allows an irregularity on the route of the test signal to be detected.

Therefore, depending on the arrangement of the conducting elements on the surface of the cable, it is possible to detect mechanical rubbing at certain points of this surface.

The arrangement illustrated in FIG. 4 of two conducting wire elements wound in a spiral is particularly suitable for a cable or any cylindrically shaped object. This arrangement is, however, not limiting and a person skilled in the art can easily adjust the positioning of the conducting elements in the overlayer according to the surface to be protected.

The use of a pair of conducting elements is also not limiting. Any number, two or more, of conducting elements can be used, as will be explained below.

In the case of a metal surface to be protected, it is also possible to use single conducting elements instead of pairs of conducting elements, the second element of the pair being formed by the metal surface itself.

A single conducting element can also replace the assembly formed from the pair of conducting elements connected by a short circuit or a resistive load.

The test device 405 can be a test equipment separate from the overlayer. In this case, it is suitable for being connectable to at least two input ports of the overlayer which are connected to two ends of a conducting element, respectively.

However, the test device 405 can also be integrated into the overlayer in the form of a miniaturized integrated circuit directly connected to the ends of the conductors.

Advantageously, the wire conducting elements used have sufficiently small diameters to allow the detection of a fault at the surface of the overlayer with the required accuracy.

In a particular embodiment of the invention, the wire conducting elements are nanowires, the diameter of which is in the nanometer range. An advantage of this embodiment is that the conducting elements and, therefore, the overlayer of the object to be protected are thus made invisible. Therefore, the surface of the object to be protected is always visible to the user.

FIG. 5 illustrates, in relation to the same example as that of FIG. 4, how to improve the accuracy for detecting the faults by modifying the design of the conducting element infrastructure.

Configuring the distance D between two adjacent spires of two conducting elements 402, 403 or of a single conducting element sets the accuracy for detecting a fault at the surface of the cable.

Indeed, reducing the distance D (as illustrated at the bottom of FIG. 5) increases the surface of the cable covered by the conducting elements and therefore the detection total surface.

FIG. 6 illustrates a particular embodiment of the invention using conducting elements of different mechanical resistances.

The right-hand side of FIG. 6 shows an overlayer containing three conducting elements 601, 602, 603 with different mechanical resistances to rubbing.

The mechanical resistance of a conducting element can be configured notably according to the type of material of the conductor, to the diameter thereof or to the thickness of the insulating material or by any other known means.

Using several conducting elements of different mechanical resistances allows various levels of detection and warning to be achieved. In other words, a first conducting element 601 can have a mechanical resistance to rubbing of a first level while a second conducting element 602 has a mechanical resistance to rubbing of a second level greater than the first level.

The test device then detects a fault on the first conducting element 601 and/or on the second conducting element 602 depending on the strength of the rubbing (or, by analogy, the heating or the disturbance) which allows not only binary information on the event associated with the presence or the absence of a fault to be obtained but also information on the strength of the disturbance.

According to another alternative embodiment of the invention, when a reflectometry test is used to detect and locate a fault, various levels of detection and warning can be obtained by measuring the energy level of the signal reflected at the area of the fault.

FIG. 7 illustrates a possible use of the invention for locating faults.

FIG. 7 shows an assembly 700, of the cable network type, comprising a main cable branch 701 and a secondary cable branch 702 connected to the main branch.

A first conducting element 703 is arranged at the circumference of the main branch 701. A second conducting element 704 is arranged on the shared part between the two branches and on the secondary branch 702.

Such an arrangement allows, by using a detection test, the fault to be, furthermore, located depending on whether it affects the main branch 701 or the secondary branch 702. For example, if a fault is detected on the main branch 701 and not on the secondary branch 702, a first item of information for locating a fault can be deduced therefrom.

The principle described in FIG. 7 for the simple case of two interconnected branches of cables can be extended to a more complex cable network since it is possible to identify each conducting element associated with each branch of the network.

FIG. 8 illustrates a particular embodiment of the invention including redundancy areas for improving the accuracy of the extent of detecting a fault.

In the example of FIG. 8, the overlayer according to the invention comprises three conducting elements 801, 802, 803 connected together by an end having a short circuit or a resistive load 804. The three conducting elements are arranged such as to obtain a redundancy area 805 wherein the detection accuracy is improved.

The test device 405 is alternately connected to two conducting elements from the three available such as to improve the accurate location of the fault.

For example, a fault is detected by using a first detection test for the conducting elements 801 and 802. A fault is then detected by using a second detection test for the conducting elements 801 and 803. By using a third detection test for the conducting elements 802 and 803, no fault is detected.

The results of the three aforementioned detection tests allows it to be concluded that the fault is located closer to the conducting element 801 since it is involved in two positive detection tests.

The principle described in FIG. 8 can be extended to a greater number of conducting elements and a greater number of detection tests associated with a decision logic for deducing a presumed proximity of the fault to one of the conducting elements in particular.

FIG. 9 illustrates another embodiment of the invention for increasing the accuracy for detecting a fault or an effect on a given area of the overlayer.

According to this embodiment, a plurality of pairs of conducting elements 901-906 are arranged in parallel with a small space between two conducting elements. For the purposes of simplification, in FIG. 9, a pair of conducting elements is represented by a single wire element.

Furthermore, each pair of conducting elements 901 has a total length reduced by a predetermined distance δ in relation to the adjacent pair of conducting elements 902 as illustrated in FIG. 9.

This embodiment is coupled with a detection test system of the reflectometry system type.

When the reflectometry system is connected to the ends of the various conducting elements, it synchronously injects the test signal onto all of the conducting elements. The signals reflected on the irregularity created by the fault 910 located in the contact area are back-propagated and arrive at the injection point with a different delay for each conducting element. Precisely, the signal reflected in the pair of conducting elements 901 arrives at the injection point at a time T, the signal reflected in the pair of conducting elements 902 arrives at the injection point at a time T+f(δ), the signal reflected in the pair of conducting elements 906 arrives at the injection point at a time T+6 f(δ). Generally, the signal reflected in de Nth pair of conducting elements arrives at the injection point at a time T+N f(δ). f(δ) is a function of the distance δ which corresponds to the delay brought about by the differences in lengths of the conducting elements.

From the set of the reflectograms collected on the various conducting elements, it is possible to carry out a spatial interpolation by taking into account the delays of the reflected signals and the waveform of the injected test signal.

The difference in length δ between two pairs of adjacent conducting elements can be constant or otherwise. Advantageously, a constant δ value allows the spatial interpolation calculations to be facilitated.

A spatial interpolation example in the case where the δ value is constant is now explained in detail. According to this example, the spatial interpolation is carried out by reforming a so-called “global” reflectogram by successively intercalating the measurements carried out on each pair of conducting elements. The global reflectogram is, therefore, formed from the first sample measured on the first pair (noted S_{1,1}, the first index being the number of the pair, the second index being the number of the measured sample), then from the first sample of the second pair S_{2,1} followed by the samples S_{3,1} S_{4,1} up to S_{N,1}, N being the number of the last pair. The reflectogram is then filled up by adding the second sample of the pairs taken one by one S_{1,2} S_{2,2} S_{3,2} S_{4,2} up to S_{N,2}. This process is repeated up to the last sample of the last pair. The resulting reflectogram contains all of the received measurements from each pair, with a spatial accuracy of δ. The analysis of this reflectogram will, therefore, give more precise information for the location of the fault, and it will also allow the identification of the element pairs most affected by the fault (in the case where only a sub-assembly of these N pairs is affected by the fault).

For optimum use of this system, the time period for injection of the signals, in other words the duration between the injections of two successive signal samples on a same pair of conducting elements is equal to (N+1) δ.

Other known spatial interpolation methods equivalent to that described above can be envisaged without departing from the scope of the invention.

The invention has the advantage of allowing a preventative detection of the failures due to faults affecting the surface of any object. When a fault is detected, the overlayer can be easily repaired by replacing the conducting element associated with the detection. This can be carried out before the protected surface is, itself, damaged, hence the preventative aspect. The overlayer according to the invention also plays a protective layer role for the object on which it is positioned, therefore preventing it from suffering deterioration.

Furthermore, the overlayer can be designed to offer a greater detection accuracy on the most sensitive parts of the surface of the object.

According to a particular use, the overlayer according to the invention can also include an adhesive surface for putting it temporarily onto the surface of an object. This particular use has the advantage of facilitating the repair process; when a fault is detected at the surface of the overlayer, the adhesive surface allows the overlayer to be quickly removed in order to replace it. According to this particular use, the adhesive overlayer can be broken down into several pieces such as to allow the replacement of a single piece, locally affected by a fault, instead of the entire overlayer.

According to another use of the invention, the detecting overlayer can also be used to transform the surface of an object into a tactile interface.

1. An overlayer intended to cover an object in order to detect a defect on a surface of said object, comprising an assembly made up of a plurality of current-conducting wire elements of different mechanical resistances and a means for insulating said conducting wire elements, each conducting wire element being arranged such as to at least partially cover a surface of said object when the overlayer covers said object, each conducting wire element being arranged to allow the connection thereof to a test device for detecting a fault affecting said conducting element.

2. The overlayer as claimed in claim 1 wherein said assembly comprises at least a pair of current-conducting wire elements which are connected at one of the ends thereof by a short circuit or an electric load, and are arranged such that a test signal can be injected at the other end of one of said elements of the pair.

3. The overlayer as claimed in claim 2 wherein the accuracy for detecting a defect at the surface of the overlayer is configured according to the spacing between two adjacent spires of the pair of conducting wire elements.

4. The overlayer as claimed in claim 1 wherein the mechanical resistance of a conducting wire element is configured according to the diameter of said element or to the thickness of the insulating means or to the type of material from which the conducting wire element is made up.

5. The overlayer as claimed in claim 1 wherein a conducting wire element is made up of copper or aluminum.

6. The overlayer as claimed in claim 1 wherein said current-conducting wire element is a nanowire.

7. The overlayer as claimed in claim 1 wherein the insulating means is integrated into said conducting element.

8. The overlayer as claimed in claim 1 wherein the insulating means is an insulating layer shaped to cover said object and wherein said conducting element is embedded.

9. The overlayer as claimed in claim 1 further comprising an adhesive surface for adhering to said object.

10. A test system for detecting a defect at the surface of an object comprising an overlayer as claimed in claim 1, which overlayer is shaped to cover said object, and a test device configured to implement an electric test for detecting a fault affecting at least one conducting wire element of the overlayer.

11. The test system as claimed in claim 10 wherein the test device is integrated into the overlayer.

12. The test system as claimed in claim 10 wherein the test device is suitable for implementing a reflectometry test.

13. The test system as claimed in claim 12 wherein the overlayer includes a plurality of pairs of conducting wire elements of different lengths and the test device is suitable for carrying out a spatial interpolation of the reflectograms measured on each pair of conducting wire elements.

14. A use of a test system as claimed in claim 10 wherein the overlayer comprises at least three current-conducting wire elements connected together at one of the ends thereof by a short circuit or an electric load, consisting in successively carrying out a detection test on each pair of conducting wire elements, which pair is taken from said conducting wire elements, such as to assess the extent of the fault affecting an area of the surface of the overlayer.

15. The use of a test system as claimed in claim 10 consisting in successively carrying out a detection test on a plurality of conducting wire elements of different mechanical resistances and in producing a detection warning level weighted according to the mechanical resistance of said conducting wire element on which a fault has been detected.

16. The use of a test system as claimed in claim 10 used for a cable network wherein at least one different conducting wire element is positioned at the surface of each segment of the cable network, a detection successive test on each conducting wire element allowing the segment of the network affected by the detected fault to be identified.

17. The use of a test system as claimed in claim 10 according to which said overlayer is used as a tactile interface by the detection of a rubbing fault at the surface thereof.
